(19) United States
(12) Patent Application Publication
(10) Pub. No.: US 2013/0191234 A1
(43) Pub. Date: Jul. 25, 2013

(54) IMPOSING FEE STRUCTURE BASED ON CUSTOMER BEHAVIOR

(71) Applicant: Philip FERREIRA, Danville, CA (US)

(72) Inventor: Philip FERREIRA, Danville, CA (US)

(21) Appl. No.: 13/356,383

(22) Filed: Jan. 23, 2012

(51) Int. Cl. G06Q 20/08; G06Q 30/08

(52) U.S. Cl. 705/26.3; 705/30

(57) ABSTRACT

Techniques for assigning values to existing and potential customers, based on their behavior, for the purpose of deciding when to impose a fee structure on the customers are provided. For example, in an embodiment, a computer algorithm receives and evaluates behavior of existing and potential customers and subsequently generates and assigns values to the existing and potential customers based on their behaviors. Based on the generated and assigned value to an individual customer, a particular fee structure is imposed on the individual customer. An assigned value may change to reflect change in the evaluated behavior of the existing or potential customer, which may cause a change in the current imposed fee structure. For example, an assigned value may increase when an individual customer's online transactions become more successful and the fee structure may change to cause the customer's fees to increase.

### BACKGROUND OF THE INVENTION

1. Technical Field

This invention relates generally to the field of online transactions. More specifically, this invention relates to implementing a model for determining when to impose a fee structure based on customer behavior in online transactions.

2. Description of the Related Art

Online transactions have been available for ordinary customers for some time, now. Two business models have been the primary drivers for most companies with respect to their online business and retaining customers.

One typical practice for retaining clientele is offering a potential consumer a short, promotional period when they sign up for the product or service in question. For instance, the consumer may be given 90 days to use the service or product, at which point the consumer is required to make a decision. The consumer must decide whether to subscribe to or otherwise pay for the service or product or walk away from it, i.e. use the service or product no longer.

Another typical practice for retaining clientele is for a company at the time of launching his or her new service or product to offer all potential customers at the same time a promotional period for a particular number of days, e.g. 30 days, at which point the price goes up for everybody.

It would be advantageous to provide an optimized solution to the problem of retaining potential customers that reflects particular aspects of the customer's behavior, rather than having a one-size fits all solution.

### SUMMARY OF THE INVENTION

Techniques for assigning values to existing and potential customers, based on their behavior, for the purpose of deciding when to impose a fee structure on the customers are provided. For example, in an embodiment, a computer algorithm receives and evaluates behavior of existing and potential customers and subsequently generates and assigns values to the existing and potential customers based on their behaviors. Based on the generated and assigned value to an individual customer, a particular fee structure is imposed on the individual customer. An assigned value may change to reflect change in the evaluated behavior of the existing or potential customer, which may cause a change in the current imposed fee structure. For example, an assigned value may increase when an individual customer's online transactions become more successful and the fee structure may change to cause the customer's fees to increase.

### BRIEF DESCRIPTION OF THE DRAWINGS

FIG. 1 is a flow diagram showing the interaction between a customer and the system, according to an embodiment;

FIG. 2 is an example implementation of the flow diagram in FIG. 1 in the context of online auctions, according to an embodiment; and

FIG. 3 is a block schematic diagram of a system in the exemplary form of a computer system according to an embodiment.

### DETAILED DESCRIPTION OF THE INVENTION

Techniques for assigning values to existing and potential customers, based on their behavior, for the purpose of deciding when to impose a fee structure on the customers are provided. For example, in an embodiment, a computer algorithm receives and evaluates behavior of existing and potential customers and subsequently generates and assigns values to the existing and potential customers based on their behaviors. Based on the generated and assigned value to an individual customer, a particular fee structure is imposed on the individual customer. An assigned value may change to reflect change in the evaluated behavior of the existing or potential customer, which may cause a change in the current imposed fee structure. For example, an assigned value may increase when an individual customer's online transactions become more successful and the fee structure may change to cause the customer's fees to increase.

### An Overview

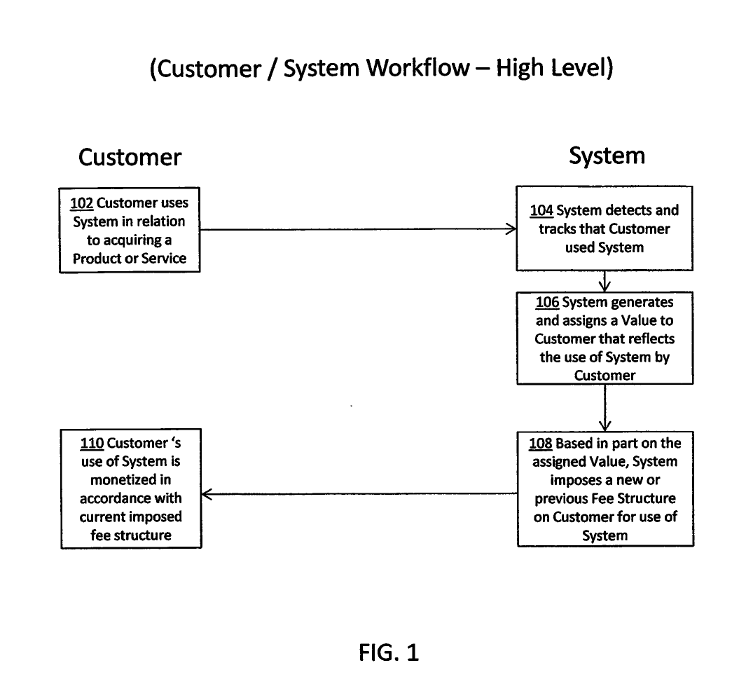

An embodiment may be understood with reference to FIG. 1, a flow diagram showing the interaction between a customer and the system. At step 102, a customer uses a system, configured in accordance with an embodiment, in relation to obtaining a product or service. At step 104, the system is configured to detect that the individual customer has used the system. The system is further configured to track that the customer has used the system. At step 106, in response to the system detecting and tracking that the customer is using the system, the system, based on this current use and prior uses, generates a value that reflects this and prior uses of the system. After generating the value, the system assigns the value to the customer. At step 108, based in part on the assigned value, the system imposes a fee structure to the customer for the use of the system. At step 110, in response to the imposed fee structure, the customer's use of the system going forward is monetized in accordance with the current fee structure. The flow repeats (not shown) each time the customer uses the system, starting at step 102, in relation to a product or service, whether the same or different product or service.

### A First Example Implementation

### Auction System for Cars

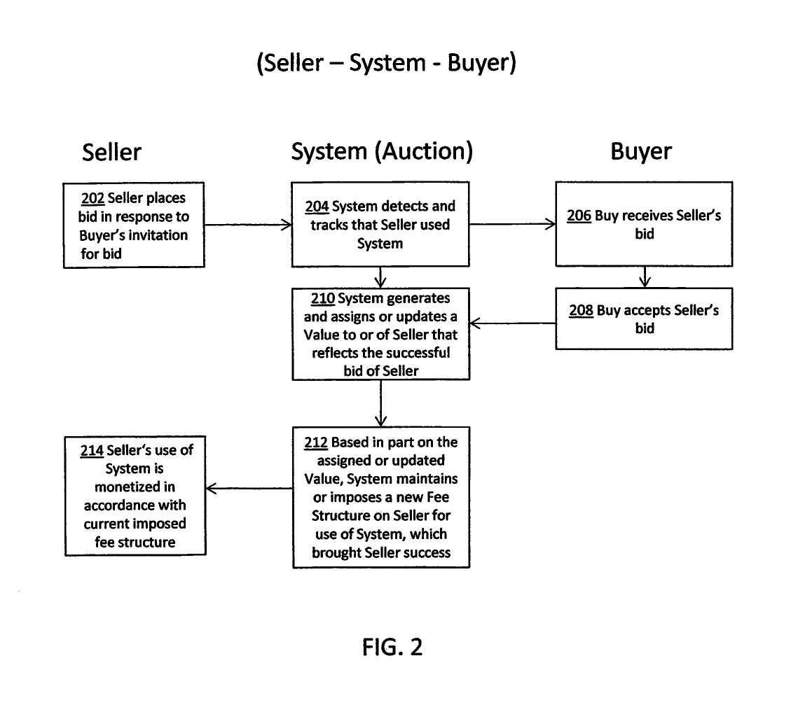

An embodiment may be understood with reference to FIG. 2, an example implementation in the context of online auctions. At step 202, a seller places a bid into an online auction system in response to a buyer's invitation to bid. An example context may be an auction system for online sales of cars. For instance, the Buyer may have previously entered into the auction system information about a type of car he would like to purchase. The auction system may be configured to link to potential sellers of that type of car. Thus, the Seller at step 202 may have previously received an invitation to bid via the auction system from the buyer (not shown), which then leads to step 202.

At step 204, the system detects that the seller has placed a bid. As well, the system may contain a tracking mechanism that tracks the use of the system by this particular seller.

At step 206, the buyer receives the bid via the auction system.

At step 208, in this particular example, the buyer accepts the seller's bid. It may be the case that the buyer does not accept the seller's bid. When the buyer does not accept the seller's bid, the subsequent steps may depend on the particular configuration of the auction system in accordance with enterprise desires and rules.

At step 210, the auction system, now aware that the seller's bid is successful, generates and assigns to the seller a value that reflects that the bid was successful. On the other hand, it may be the case that this successful bid of the seller is not the first successful bid. Thus, in this case the value reflecting success bids of the seller has been previously generated and assigned to the seller and may need only to be updated.

At step 212, based on the current value assigned to the seller, the system imposes a fee structure. It may be the case that this successful bid of the seller is the initial successful bid and a fee structure had not been previously imposed on the seller. Or, it may be the case that every initial seller of the system has a default fee structure imposed on him or her. For example, such initial fee structure may be configured such that the first few, e.g. five, successful bids are free. Thus, it may be that this is the third successful bid for the seller and the auction system maintains the current fee structure. It may be that this is the sixth successful bid and the auction system changes or imposes a new fee structure on the seller which had a more aggressive payment schedule. For purposes of discussion herein, a more aggressive payment schedule may mean greater fees are applied or more frequent payments are required. It should be appreciated that the details above are by way of example only and are not meant to be limiting.

At step 214, the particular fee structure determined at step 212 is now associated with the seller to be applied at future uses of the system.

Thus, embodiments herein identify those customers who have adopted a system that was initially free of charge or inexpensive to use as a standard practice over time. In the example above, the system was a business system, i.e. an online auction system, which imposed a fee structure on the identified individuals after use of the product or service, thereby increasing the likelihood of retention after a price plan commencement or increase. The seller that initially participates is not charged. But then, over time, as the seller receives success, and they start selling their goods through this auction, then the system starts to propose a percentage of each sell to maintain the subscription of the service. Or, alternatively, the system may use a flat fee or some other mechanism of charging the seller.

Embodiments herein are configured to allow the user the chance to use the technology, e.g. bid for free, and then as the usage, e.g. bidding, starts to provide value to the user, the system starts to bill the user. That is, the system does not allow the user to continue to use the product or service, e.g. bidding service, for free. The service becomes a fee-based service or system.

Put another way, instead of instigating a global pricing plan for all customers, embodiments herein begin monetizing only those customers who appear to have become dependent on the system.

### A Second Example Implementation

### Auction System for Purses

This second example, as with the first, exemplifies the unique value or genius of embodiments herein in the world of businesses to consumers (“B to C”) for large transactions, i.e. where businesses or enterprises conduct lots of sales of something that is a commodity.

As an example, suppose a consumer desires to buy a high-end purse and that there are 12 companies that sell high-end purses. In an embodiment and in this example, the system presents the consumer with five of the 12 selling companies for free. In this example, the consumer picks another five from the 12 companies. The system charges $5 for each additional high-end purse company that the consumer wants to bid on this purse. In this example, the system does not charge any of those ten companies to allow them to try to sell their wares. But later, as they become more successful in selling these high-end purses, i.e. as these companies start to win on the bidding, the system determines and imposes a fee structure on these companies. In an embodiment, an algorithm is provided that analyzes their success, the dollar amount, and other factors. Then, the next time one of those sellers comes in through the system, the system asks them to subscribe to the system.

### Problem

An example problem is as follows. It has been found difficult to get users of an online service to pay for the service when they previously have been given a free or promotional period. The proprietor of the server cannot all of a sudden give every user a 30-day or 90-day period and then move them to the fee-based service. Such strategy does not work or does not benefit the proprietor because the users have not firmly adopted the business model, e.g. using the service, universally. Some users may adopt the business model very quickly and others may take years to adopt it. And, some may never adopt it.

### Solution

Thus, an embodiment provides a solution in the form of an algorithm, which looks at when a customer has essentially adopted the product or service as the way they can start to do business. They use it on a regular basis. The algorithm is an optimized algorithm that determines the customer is using the service or product on a regular basis. Thus, the optimized algorithm automatically implements a fee structure just on that individual customer at that time of discovering he or she is now a regular, consistent user. The optimized algorithm serves the purpose of retaining customers as opposed to charging them too soon, which can drive them away, or too late, when the proprietor could have been monetizing the customers sooner.

### In Contrast to Prior Art Standard Practices

One typical practice for retaining clientele is offering a potential consumer a short, promotional period when they sign up for the product or service in question. For instance, the consumer may be given 90 days to use the service or product, at which point the consumer is required to make a decision. The consumer must decide whether to subscribe to or otherwise pay for the service or product or walk away from it, i.e. use the service or product no longer.

Another typical practice for retaining clientele is for a company at the time of launching his or her new service or product to offer all potential customers at the same time a promotional period for a particular number of days, e.g. 30 days, at which point the price goes up for everybody.

In stark contrast, an embodiment herein provides a unique methodology in that a promotional period applies universally when customers first sign up. In fact, a customer may not even realize that he or she is in the promotional period. Subsequently, the status of the customer with respect to particular factors reflecting the ongoing relationship between the customer and the system may change. Examples of such factors may include the number of times the customer uses the system and the cost of product or service. Essentially, the changes in the behavior of the customer may cause the system to determine that this is a customer the proprietor is not willing to lose. Thus, the algorithm determines when it is safe to begin implementing a monetization fee structure upon the customer, while at the same time retaining the customer.

### The Algorithm

In an embodiment, an algorithm is provided that may be dependent on the product or service that is being provided to the customers. For example, in the case including an auction system, several factors are used to determine when to impose a fee structure or fee-based service. Examples of such factors may include, but are not limited to, determining how often the customer logs into the system. Are they logging in daily? Are they logging in weekly or monthly? How often are they placing bids on the auction model? Are they placing bids daily? Weekly? Monthly? And, so forth.

Point at which Product or Service is of Value

In an embodiment, once a customer hits a certain metric, which may be determined based on product, and the algorithm determines that the customer's use is now regular use, then the next time that customer logs into the system, the customer will experience a pay system or fee-based system. In an embodiment, the system may walk the customer through the sign up period, letting the customer know what his or her fee structure is going to be moving forward. It should be appreciated that at this point, there is little fear of losing such customer, because the product or service is of value to them at that point.

On Individual Rather than on a Group

Thus, embodiments herein configured with the algorithm provide a new way of implementing a fee structure on a mass customer base over time on an individual rather than on a group, as does the prior art.

### A Third Example Implementation

### Auction System for Cars

An embodiment may be understood by the following fully-described scenario of a consumer performing the operations of buying a car online. It should be appreciated that the following example and particular details therein are for illustrative purposes only and are not meant to be limiting. One skilled in the art would readily recognize that other details, entities, or operations, may be added, exchanged, or omitted and the teaching would still be within the scope and spirit of the invention.

A consumer comes to the online service (“the system”) and indicates that they want a vehicle, new or used. Over a particular time period, e.g. a seven-day period, the system runs an auction, e.g. a reverse auction. The auction itself may have nothing to do with the monetization aspect of the embodiment, but may have to do with product background.

Over a time period, many different dealers, e.g. up to a hundred different dealers, that sell that particular vehicle arrive at the system and bid against each other. Each dealer may place a bid and lower the price of the vehicle for the consumer.

The system may charge the consumers a fee to request bids for a vehicle. The more dealers they invite, the more they pay. From the dealers' perspective, an embodiment makes this model, e.g. the opportunity to bid, initially free.

It should be appreciated that that free period is for that market, the auction market for cars, or part of market, only. The free period cannot be locked in for every dealer. For example, the free period may be based in part on the geographical region of the dealer within the nation.

The system evaluates dealers as they start to enter and use the system. For example, certain dealers may log in on a daily basis to place their bids. The system may determine that they are now adopting the system. They are using the system on a regular basis to acquire new leads or new sales through the auction process.

Once the system determines that the dealer has hit whatever metric is set, the system has determined that this dealer is ready to start paying the next time the dealer logs in. An example of when a metric is met is when a dealer is logging on at least once every 72 hours, is actively bidding, e.g. is placing three or four bids a week, and has hit that metric for four weeks in a row. It has previously been determined by the proprietor that when the dealer uses the system enough to meet the metric, the dealer sees value in the system. It may be assumed that the dealer is generating sales or leads on his or her side as a result of these bids.

Then, the next time the dealer logs in and the system has determined that now this dealer is ready to start paying, the dealer may be funneled through a credit card or payment sign-up page. For example, the page may say, “Thank you for using our auction process. We appreciate your business. In order for you to continue participating in the auction process, we now require you to pay a subscription fee of $100 per month.”

That dealer then goes through the process of filling out a credit card or inputting his or her billing information, such that the dealer may get back into the system and participate just as he or she had participated consistently in the past time period, e.g. three months in this case.

If that dealer does not complete the billing information and does not come back to the system for a period of time, for example, two weeks, the system may notify a sales representative on the enterprise-side. The enterprise's sales representative may subsequently contact the dealer and find out what is the holdup. Is the dealer just unwilling to pay? Is the person logging in not the right person? Does the sales representative need to get authorization from a manager to reset the dealer's account?

### Further Discussion

### Other Business Utilities

In an embodiment, any subscription—based service is a good candidate for using the techniques discussed herein. For example, LinkedIn may implement their existing free model and, once a registered user meets their criteria defined as an adopter user, impose a fee structure. Examples of their criteria may include login frequency per week, page views per session, gross time on site, and repetitive use of very specific features that indicate the optimum time to monetize the user. Another example may be Twitter that could implement the techniques discussed herein. For example, Twitter may base their implementation on the user's number of Tweets, time online, number of followers, etc. Facebook may also implement the techniques discussed herein based on, e.g. number of friends, number of photos, and other behaviors indicative that the user is now reliant on the service.

A Customer Relationship Management (CRM) service provider may also be a type of candidate industry for implementing the techniques described herein. For example, a CRM service provider may get a foothold in a crowded marketplace by providing their services for free until it is determined the company and possibly their customers are utilizing the service often enough to begin monetizing them.

Another space that may implement the techniques discussed herein includes online and mobile content providers. Such providers may similarly provide their content, e.g. Fox News, NY Times, and TechCrunch, via their apps or websites for free until it is determined a specific reader is hooked on the content and begin imposing fee(s) on that particular user.

It should be appreciated that the techniques discussed herein are distinguished from those implemented by businesses that charge fees based on volume. An example of such other implementations is by email service providers that increase their fees based on the number of emails sent per month. That is, some companies presently may offer a free service until the client meets a certain volume threshold. It should be appreciated that the techniques described herein are an added layer to those models. That is, according to approaches taught herein, services are provided free of charge to a client until the client's behavior indicates their adoption of the model, regardless of volume. Their volume of use is a determinant of their price point, whereas their adoption of the product is the timeline to impose the fee structure(s), in accordance with approaches taught herein.

### An Example Machine Overview

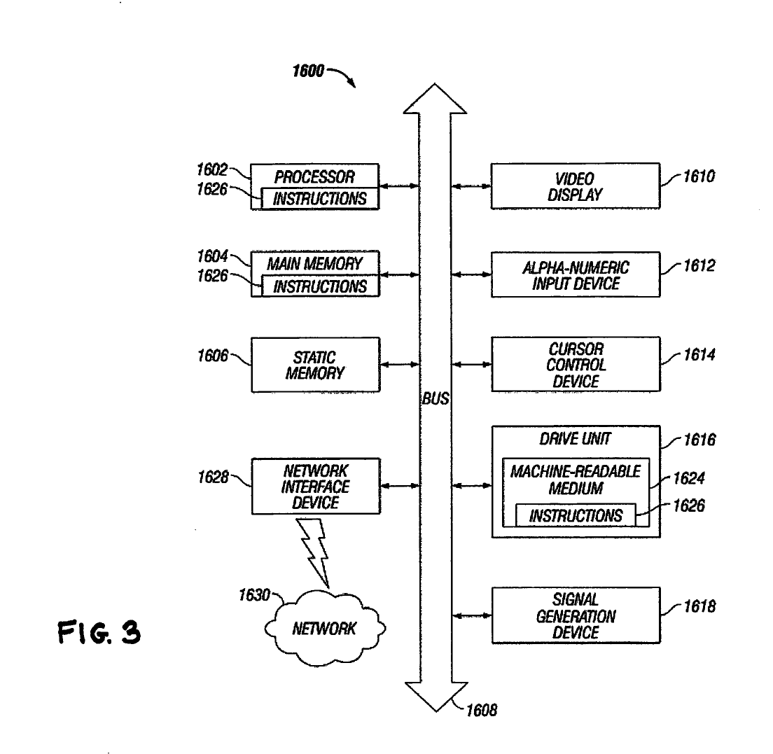

FIG. 3 is a block schematic diagram of a system in the exemplary form of a computer system 1600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer-implemented method for imposing fee structure based on customer behavior, comprising the steps of:
detecting that a user has logged in and used one or more features;
responsive to detecting that the user used one or more features, tracking said usage;
responsive to tracking said usage, computing a value or updating said value and assigning or re-assigning said value to the user; and
responsive to assigning or re-assigning said value to the user, imposing a fee structure on the user that is based on said value;
wherein when said value reaches or crosses a threshold value, said fee structure causes the user to be required to make a subscription or payment when the user subsequently logs in again, and
wherein at least one of the steps is performed by a processor.

2. The method of claim 1, wherein the fee structure is a new fee structure or wherein the fee structure is a same fee structure that has previously been imposed on the user.

3. The method of claim 1, wherein tracking comprises tracking how often the user logs in during a first time period, how often the user used a particular feature during a second time period, and both conditions over an entirety of a third time period.

4. The method of claim 1, wherein computing the value is based in part on the one or more features.

5. The method of claim 1, wherein said imposed fee structure is a new fee structure.

6. The method of claim 1, wherein said imposed fee structure is an initial fee structure which comprises an initial free period.

7. The method of claim 5, wherein the new fee structure comprises a more aggressive payment schedule.

8. The method of claim 1, wherein said user is a seller of commodities, said one or more features are features of an online auction system for reverse auctions, said one or more features comprises bidding and receiving an acceptance of a bid, and said value is a metric that reflects how often the seller's bids have been accepted.

9. An apparatus for imposing fee structure based on customer behavior, comprising:
a detecting processor for detecting that a user has logged in and used one or more features;
a tracking processor for tracking said usage, responsive to said detecting that the user used one or more features;
a computing and assigning processor for computing a value or updating said value and assigning or re-assigning said value to the user, responsive to said tracking said usage; and
an imposing processor for imposing a fee structure on the user, said fee structure based on said value, responsive to said assigning or re-assigning said value to the user,
wherein when said value reaches or crosses a threshold value, said fee structure causes the user to be required to make a subscription or payment when the user subsequently logs in again.

10. The apparatus of claim 9, wherein the fee structure is a new fee structure or wherein the fee structure is a same fee structure that has previously been imposed on the user.

11. The apparatus of claim 9, wherein tracking comprises tracking how often the user logs in during a first time period, how often the user used a particular feature during a second time period, and both conditions over an entirety of a third time period.

12. The apparatus of claim 9, wherein computing the value is based in part on the one or more features.

13. The apparatus of claim 9, wherein said imposed fee structure is a new fee structure.

14. The apparatus of claim 9, wherein said imposed fee structure is an initial fee structure which comprises an initial free period.

15. The apparatus of claim 13, wherein the new fee structure comprises a more aggressive payment schedule.

16. The apparatus of claim 9, wherein said user is a seller of commodities, said one or more features are features of an online auction system for reverse auctions, said one or more features comprises bidding and receiving an acceptance of a bid, and said value is a metric that reflects how often the seller's bids have been accepted.

17. A non-transitory computer readable medium having stored thereon a computer program for imposing fee structure based on customer behavior, said computer program comprising a program code which, when executed by a processor, performs the steps of:
detecting that a user has logged in and used one or more features;
responsive to detecting that the user used one or more features, tracking said usage;
responsive to tracking said usage, computing a value or updating said value and assigning or re-assigning said value to the user; and
responsive to assigning or re-assigning said value to the user, imposing a fee structure on the user that is based on said value;
wherein when said value reaches or crosses a threshold value, said fee structure causes the user to be required to make a subscription or payment when the user subsequently logs in again.
